(19) United States
(12) Patent Application Publication
(10) Pub. No.: US 2017/0253159 A1
(43) Pub. Date: Sep. 7, 2017

(54) Automobile Seat Cover

(71) Applicant: CL Product Group, LLC, Belleair, FL (US)

(72) Inventor: Tiffanie Lopatin, Belleair, FL (US)

(21) Appl. No.: 15/059,896

(22) Filed: Mar. 3, 2016

(51) Int. Cl. B60N 2/60; B60N 2/28; B60R 7/04

(52) U.S. Cl. CPC B60N 2/6063; B60R 7/043; B60N 2/6054; B60N 2/2806; B60N 2/60

(57) ABSTRACT

The disclosed invention is an improved seat cover that prevents slipping or pulling off of the seat back during use. The improved seat cover utilizes an additional panel of material that is tucked between the seat back and seat bottom of a car seat. The disclosed invention fits a variety of seat types and can accommodate arm rests and child safety seat latches. In certain embodiments of the improved seat cover, the additional panel of material includes slots through which child safety restraints may be anchored without the removal of the seat cover.

### FIELD

The present invention relates generally to protective covers for automobile seats, and more particularly, to an improved one-piece protective seat cover which is adjustable to fit automobile seats having different sizes and to allow the functionality of the vehicle seat arm rests and child seat safety latches.

### BACKGROUND

The advantages of automobile seat covers have long been recognized by consumers for the protection of seat upholstery and/or for covering worn or damaged upholstery. Accordingly, there exists a myriad of designs of seat covers aimed at solving various problems, such as, but not limited to the fit and attachment to numerous styles of automobile seats.

While the devices heretofore meet their respective, particular objectives and requirements, the need remains for an improved seat cover that has certain improved features that allow for an adjustable fit to various seat designs, and which is easily installed and removed for laundering once becoming soiled.

### SUMMARY

The embodiments of the present invention address the needs presented above by providing a seat cover of an improved, one-piece design having a seat covering portion and a back rest portion that are slipped onto an automobile seat, and which is retained thereon simply by the virtue of its construction without the use of straps with hooks or other structure engaging fasteners.

One embodiment of the present invention provides a seat cover that is constructed from a machine washable fabric.

A second embodiment of the present invention provides a seat cover that is water resistant and may include a water resistant liner.

A third embodiment of the present invention provides a seat cover that is usable with child safety devices, such as car seats or booster seats by providing access to seat safety latching points.

A fourth embodiment of the present invention provides a seat cover including provisions for an automobile seat head rest and armrests.

A fifth embodiment of the present invention provides a seat cover including a specially designed tuckable panel which operates to adjust and secure the fitting of the seat cover to the seat.

Numerous objects, features, and advantages of the present invention will be readily apparent to those of ordinary skill in the art upon a reading of the following detailed description in conjunction with the accompanying drawings. Also, it is to be understood that the phraseology and terminology employed herein are for the purpose of descriptions and should not be regarded as limiting.

### BRIEF DESCRIPTION OF THE DRAWINGS

The invention can be best understood by those having ordinary skill in the art by reference to the following detailed description when considered in conjunction with the accompanying drawings in which:

FIG. 1 is a left-side perspective view of an automobile seat cover constructed in accordance with the principles of the present invention installed on a captain's style automobile seat;

FIG. 2 is a rear view of the automobile seat cover installed on the automobile seat;

FIG. 3 is a right-side perspective view of an automobile seat cover constructed in accordance with the principles of the present invention;

FIG. 4 is an enlarged, partial cross-sectional view of an automobile seat cover constructed in accordance with the principles of the present invention installed on an automobile seat, illustrating a tuckable panel disposed within the gap between the seat and back rest of the automobile seat and a safety latch extending through a slot in the tuckable panel;

FIG. 5 is an enlarged, partial view of a front panel and a seat panel joined together by a tuckable panel;

FIG. 6 is a partial perspective view of a tuckable panel illustrating an open safety latch slot extending through the tuckable panel and a fastener for sealing the slot; and

FIG. 7 is a cross-section through a seat panel of the seat cover.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

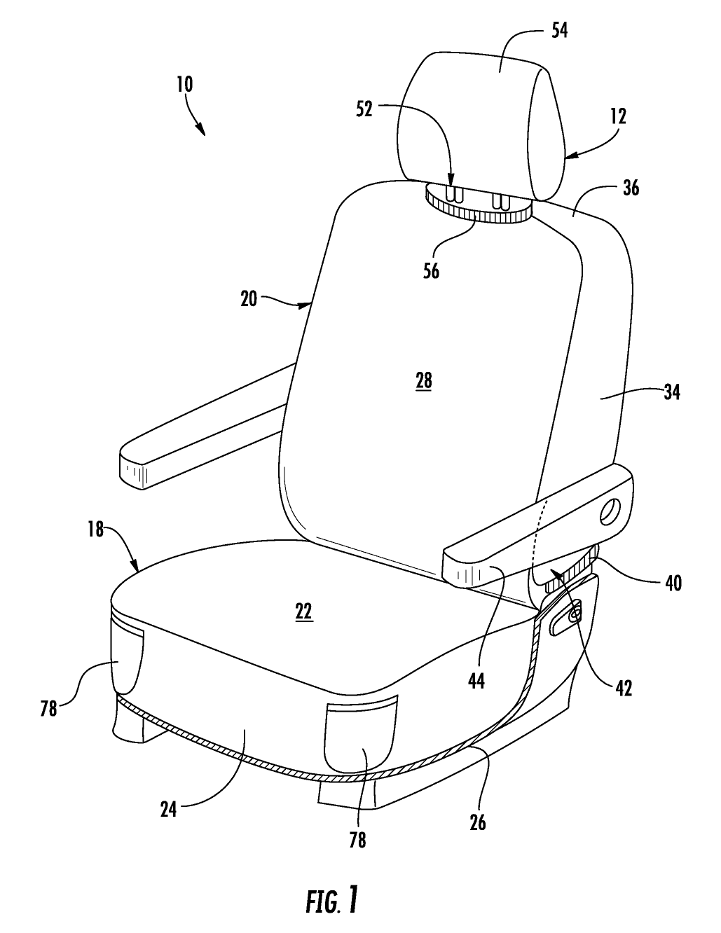

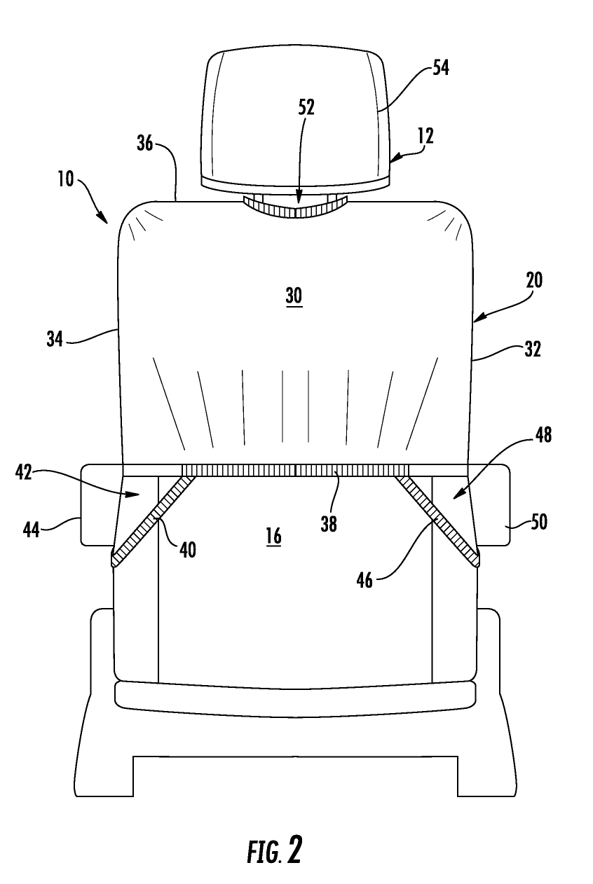

With reference now to FIGS. 1 through 7, an automobile seat cover incorporating the principles and concepts of an embodiment of the present invention and generally designated by the reference numeral 10 will be described.

As best illustrated in FIGS. 1 through 5, the seat cover 10 is of a one-piece, or unitary, slip cover construction permitting easy installation and removal of the seat cover 10 on an automobile seat, and particularly, a captain's chair style automobile seat 12 having a seat cushion 14 and a back rest 16.

The seat cover 10 comprises a seat portion or a bottom portion 18 constructed to cover the seat cushion 14 of automobile seat 12, and a back portion 20 constructed to cover the back rest 16 of the automobile seat 12. The seat portion 18 has a seat panel 22 of a sufficient size to cover the top of seat cushion 14 of the automobile seat 12.

The seat portion 18 further includes a peripheral skirt 24 descending from the seat panel 22 and extending along at least the front and two opposing sides of the seat panel 22. The bottom edge of the skirt 24 is fitted with an elastic band or similar material 26 to cause the skirt 24 to fit snuggly about the seat cushion 14.

The back portion 20 includes a front panel 28 of a sufficient size to cover the forward surface of the back rest 16 and a back panel 30 joined to the front panel 28 by opposing side panels 32 and 34 and top panel 36. Front panel 28, back panel 30, side panels 32 and 34, and top panel 36 together provide a sleeve having an opening opposite the top panel 36 which can slide over the back rest 16 with the back rest 16 disposed within the interior of the sleeve construction. The bottom edge of the back panel 30 is fitted with an elastic band or similar material 38 to cause a cinch in the sleeve construction of the back portion 20 about the back rest 16. Additionally, an elastic strap 40 is connected to and extends between the bottom edge of the back panel 30 and a lower end of side panel 34 forming an armrest opening 42 through which an armrest 44 of the automobile seat 12 may extend. Similarly, an elastic strap 46 is connected to and extends between the bottom edge of the back panel 30 and a lower end of side panel 32 forming an armrest opening 48 through which an armrest 44 of the automobile seat 12 may extend.

The back portion 20 may further include a headrest opening 52 extending through the top panel 36 thereof, through which a headrest 54 may extend. Headrest opening 52 may be fitted with an elastic band or similar material 56 to cinch the headrest opening and permit expansion of the headrest opening 52 when a headrest 54 is passed therethrough.

Seat cover 10 further includes a tuckable panel 58. The tuckable panel 58 connects the seat panel 22 of the seat portion 18 and the front panel 28 of the back portion 20. The tuckable panel 58 is provided to be tucked into the gap 60 that extends between the seat cushion 14 and the back rest 16 of the automobile seat 12 to pull the seat panel 22 and the front panel 28 snug with the seat cushion 14 and back rest 16, respectively. The tuckable panel 58 provides universal fitting of the seat cover 10 to variously sized automobile seats.

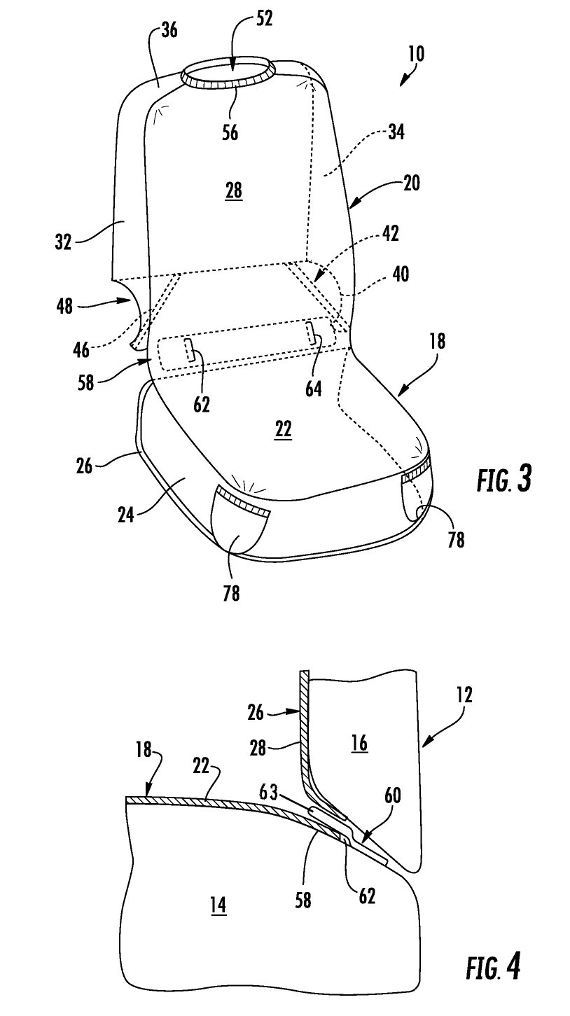

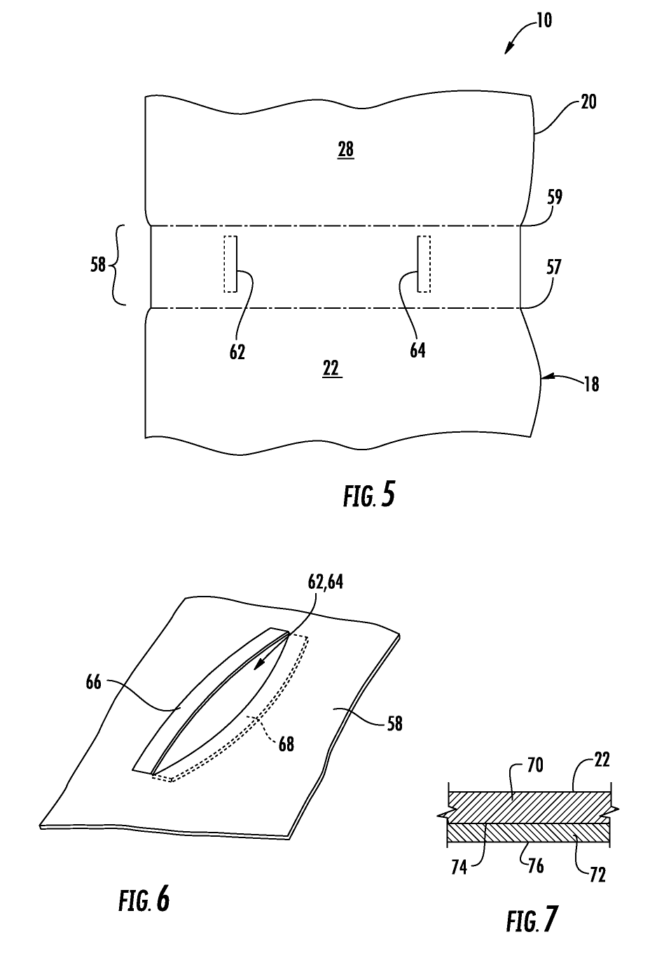

As best seen in FIGS. 4 and 5, the tuckable panel 58 may also include a pair of longitudinal slits or slots 62 and 64 that are laterally spaced a distance equal to the spacing between standard safety latching points 63 for child safety restraints, such as car seats and booster seats. In use, a safety latching point 63 is extended through a respective slot 62, 64 permitting access thereto for the installation and securement of a child safety restraint (not shown). Slots 62 and 64 may be fitted with a fastener to permit sealing of each slot when not in use to prevent debris and liquid from traveling through the slot and soiling the underlying seat.

With reference to FIG. 6, and in an embodiment, each slot 62, 64 may be fitted with a hook-and-loop type fastener to permit sealing thereof. In such an embodiment, a hook portion 66 is disposed along one edge of the slot and the corresponding loop portion 68 is disposed along the opposite edge of the slot such that the opposite edges of the slot may be overlapped and pressed together, thereby joining the hook portion 66 and loop portion 68 of the hook-and-loop fastener and sealing the slot 62, 64.

Seat cover 10 may be constructed of any suitable material including but not limited to cotton, cotton blends, polyester, polyester blends, velour, terrycloth, polycotton, knits, denim, cotton/spandex blends, neoprene, or wool as desired based upon application.

FIG. 7 illustrates a cross section view of an embodiment where at least the seat panel 22 is of a layered construction including a fabric or top layer 70 having an interior water proof coating or liner 72 along the bottom or interior surface 74 of layer 70. The coating or liner 72 serves to prevent liquids from passing through the seat cover 10 and soiling the underlying seat upholstery. In one embodiment, coating or liner 72 may be rubberized or the like to provide a friction interface between the seat cover 10 and the underlying seat to prevent slipping/bunching of the seat cover 10. In other embodiments, the interior surface 76 of coating or liner 72 may be textured or otherwise treated to have a texture to provide a friction interface between the seat cover 10 and the underlying seat.

In other embodiments, the seat cover 10 may further include one or more storage pockets 78 disposed on the skirt 24. The pockets 78 may include an elasticized opening and may further include suitable fasteners for sealing the pockets.

Additionally, while not depicted, in other embodiments, the seat cover 10 may have imprinted thereupon or otherwise include various aesthetic designs or patterns as desired. For example, in one embodiment, the seat cover 10 may have animal prints, character prints, or abstract/non-abstract designs.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. An automobile seat cover, the automobile seat cover comprising:
a. a seat portion,
b. a back portion, and
c. a tuckable panel extending between the seat portion and the back portion, the tuckable panel joined to an upper edge of the seat portion by a first seam and to a lower edge of the back portion by a second seam, and
d. wherein the tuckable panel, the first seam, the second seam, the seat portion, and the back portion equivalent in width.

2. The automobile seat cover of claim 1, further comprising one or more openings in the tuckable panel, the one or more openings formed by:
a. a first edge, and
b. a second edge,
c. wherein the first edge overlaps the second edge.

3. The automobile seat cover of claim 2, whereby the one or more openings are each aligned with a safety latch that is configured to engage child safety restraints.

4. The automobile seat cover of claim 2, wherein the first edge and the second edge are capable of being sealed together when no child safety restraint is present.

5. The automobile seat cover of claim 1, wherein the seat portion and the back portion are lined with an elastic band.

6. The automobile seat cover of claim 1, further comprising at least one armrest opening in the back portion.

7. The automobile seat cover of claim 1, further comprising a headrest opening located on the back portion.

8. The automobile seat cover of claim 1, further comprising a waterproof and friction layer on an under side of the seat portion and the back portion.

9. A single-piece seat cover that resists pulling off the top of a seat, the seat having a seat back and a seat bottom, the seat cover comprising:
a. a seat back portion,
b. a seat bottom portion, and
c. a panel of additional material joining to a lower edge of the seat back portion and to an upper edge of the seat bottom portion, the panel of additional material equivalent in width to the seat back portion and the seat bottom portion,
d. whereby the panel of additional material is tucked between the seat back and the seat bottom to hold the back portion and the bottom portion snugly to the seat.

10. The single-piece seat cover of claim 9, wherein the panel of additional material is attached to the seat back portion by a first seam and to the seat bottom portion by a second seam.

11. The single-piece seat cover of claim 9, further comprising one or more openings in the panel of additional material, the one or more openings formed by:
a. a first edge, and
b. a second edge,
c. wherein the first edge overlaps the second edge.

12. The single-piece seat cover of claim 11, whereby the one or more openings are each aligned with a safety latch that is configured to engage child safety restraints.

13. The single-piece seat cover of claim 11, wherein the first edge and the second edge are capable of being sealed together when no child safety restraint is present.

14. The single-piece seat cover of claim 9, further comprising a waterproof and friction layer on an under side of the seat bottom portion and the seat back portion.

15. The single-piece seat cover of claim 9, further comprising a headrest opening and at least one armrest opening in the back portion.

16. A seat cover designed to resist pulling off the top of an automobile seat during use comprising:
a. a back portion, the back portion comprising:
i. a front panel,
ii. a back panel,
iii. a top panel,
iv. a left side panel, and
v. a right side panel,
vi. wherein the front panel, the back panel, the top panel, the left side panel, and the right side panel form a sleeve that slides over a back rest of an automobile seat;
b. a bottom portion, the bottom portion comprising:
i. a seat panel, and
ii. a peripheral skirt, the peripheral skirt extending down from the seat panel around three sides of an automobile seat cushion; and
c. a tuckable panel, the tuckable panel joined to a lower edge of the back panel by a first seam and to an upper edge of the seat panel by a second seam, and
d. the back panel, the seat panel, and the tuckable panel equivalent in width.

17. The seat cover designed to resist pulling off the top of an automobile seat during use of claim 16, wherein the tuckable panel further comprises two slots, each slot allowing a safety latch to extend therethrough for connection to a child safety restraint device.

18. The seat cover designed to resist pulling off the top of an automobile seat during use of claim 16, further comprising a band of flexible material lining the back portion and the bottom portion.

19. The seat cover designed to resist pulling off the top of an automobile seat during use of claim 16, further comprising a headrest opening located on the top panel of the back portion, the headrest opening being lined with a band of flexible material.

20. The seat cover designed to resist pulling off the top of an automobile seat during use of claim 16, further comprising:
a. a left armrest opening on the left side panel of the back portion, and
b. a right armrest opening on the right side panel of the back portion,
c. wherein the left armrest opening and the right armrest opening are line with a band of flexible material.
